(19) United States
(12) Patent Application Publication
(10) Pub. No.: US 2008/0244398 A1
(43) Pub. Date: Oct. 2, 2008

(54) Direct Preview of Wizards, Dialogs, and Secondary Dialogs

(76) Inventors: Lucinio Santos-Gomez, Durham, NC (US); Thomas R. Haynes, Apex, NC (US); Gabriel A. Cohen, San Mateo, CA (US)

Correspondence Address: HAMILTON & TERRILE, LLP;IBM RSW, P.O. BOX 203518, AUSTIN, TX, 78720, US

(21) Appl. No.: 11/691,695

(22) Filed: Mar. 27, 2007

(51) Int. Cl. G06F 3/00

(52) U.S. Cl. 715/708

(57) ABSTRACT

A method, system and computer-usable medium are disclosed for previewing the user interaction steps of a wizard within a graphical user interface (GUI). User gestures are performed on the wizard's associated menu item or graphical icon to display a non-executable replica of the wizard in a variant visual style. The non-executable replica of the wizard is displayed in a variant visual style to signify that the wizard is in preview mode and that it cannot be executed as an active wizard. Predetermined GUI widgets (e.g., buttons, text boxes, checkmarks, etc.) are disabled and do not respond to user gestures. However, predetermined GUI navigational widgets (e.g., tabs, previous/next buttons, drop-down boxes) are enabled to allow the user to navigate from one wizard user interaction to another.

### BACKGROUND OF THE INVENTION

1. Field of the Invention

The present invention relates in general to the field of computers and similar technologies, and in particular to software utilized in this field. Still more particularly, it relates to a method, system and computer-usable medium for previewing the user interaction steps of a wizard, dialog box or secondary dialog within a graphical user interface.

2. Description of the Related Art

A graphical user interface (GUI) symbolically abstracts the underlying commands required to operate a computer system, simplifying human interaction with the computer and making it more intuitive to use. Broadly speaking, a GUI is a computer user interface that is based on graphics rather than text. Graphical elements of the GUI, such as windows, pull-down menus, buttons, scroll bars and iconic images are typically manipulated through user gestures with a pointing device, such as a mouse or a trackball. The user's interaction with the computer is facilitated by using easily understood graphical metaphors such as an arrow for pointing, folders for holding information, and a trashcan for deleting files.

Dialog boxes are special windows within a GUI that are commonly used to display information or request input from the user. Different types of dialog boxes are often implemented for different sorts of user interaction within a GUI. For example, an Alert dialog box displays a message while a software program is running and only requires an acknowledgment, such as the user clicking a button within the dialog box, to confirm that the message has been read. However, Modal dialog boxes temporarily halt the operation of the program or the computer system, which cannot continue until the dialog has been closed. As an example, a program may require additional information from the user before it can continue, or the system may wish to confirm that the user wants to proceed with a proposed course of action.

Early GUI implementations were relatively simple, but as computer applications added features and capabilities there was a corresponding increase in GUI complexity and sophistication. One aspect of this growing complexity was the number of steps and decisions required for the installation and configuration of new software applications or functionalities. As a result, interactive computer programs known as wizards were developed to automate these complex installation processes by using step-by-step GUI panels to prompt the user to make configuration choices. However, many of these wizards have reached a level of complexity where the user is unable to know in advance what steps the wizard entails, which actions they will need to perform, or the information that will need to provide to complete the wizard. For example, the user may begin the execution of a wizard only to discover that they do not have the required information to successfully complete the wizard. This inability adds an additional dynamic when modal dialog boxes are implemented in a wizard, as operation of the software application or computer system may be suspended until the user provides the required response to the dialog boxes presented by the wizard. Furthermore, without a preview of the wizard's intended actions, the user may discover that other applications may need to be shut down or other applications cannot be initiated until the wizard is successfully completed. Consequently, the lack of the ability to preview the steps, actions and requirements of a wizard can result in user frustration and have a negative effect on productivity, yet no such capability currently exists.

### BRIEF SUMMARY OF THE INVENTION

The present invention includes, but is not limited to, a method, system and computer-usable medium for previewing the user interaction steps of a wizard, dialog box or secondary dialog within a graphical user interface (GUI). In selected embodiments of the invention, computer operations are performed in a GUI until a computer wizard, dialog box or secondary dialog (hereinafter “wizard”) is selected to be previewed. User gestures, such as a mouse hover or right click are performed on the wizard's associated menu item or graphical icon to display a non-executable replica of the wizard in a variant visual style.

In one embodiment, the non-executable replica of the wizard is displayed in a translucent variant style within the GUI. The translucency of the wizard replica signifies to the user that the wizard is in preview mode and that it cannot be executed as an active wizard. In different embodiments, predetermined GUI widgets (e.g., buttons, text boxes, checkmarks, etc.) are disabled and do not respond to user gestures.

In one embodiment, predetermined GUI navigational widgets (e.g., tabs, previous/next buttons, drop-down boxes) are enabled to allow the user to navigate from one wizard user interaction to another. In these and other embodiments, if the graphical pointer is moved outside the graphical boundaries of the non-executable replica of the wizard, then the non-executable replica of the wizard is closed. In one embodiment, a user gesture performed on a predetermined widget within the replica wizard converts the non-executable replica of the wizard to an executable wizard and initiates wizard operations.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 shows a flow chart of the operation of an embodiment of a wizard preview system;

FIG. 3 shows a graphical user interface of an embodiment of a wizard preview system as implemented to view the contents and actions of a dialog box;

FIGS. 4a-b show a graphical user interface of an embodiment of a wizard preview system as implemented to iteratively view the user interaction steps of a computer wizard; and

FIG. 5 shows a graphical user interface of an embodiment of a wizard preview system as implemented to concurrently view the user interaction steps of a computer wizard.

### DETAILED DESCRIPTION

A method, system and computer-usable medium are provided for previewing the user interaction steps of a wizard within a graphical user interface (GUI). User gestures, such as a mouse hover or right click are performed on the wizard's associated menu item or graphical icon to display a non-executable replica of the wizard in a variant visual style. The non-executable replica of the wizard is displayed in a variant visual style to signify that the wizard is in preview mode and that it cannot be executed as an active wizard. Predetermined GUI widgets (e.g., buttons, text boxes, checkmarks, etc.) are disabled and do not respond to user gestures. However, predetermined GUI navigational widgets (e.g., tabs, previous/next buttons, and drop-down boxes) are enabled to allow the user to navigate from one wizard user interaction to another.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

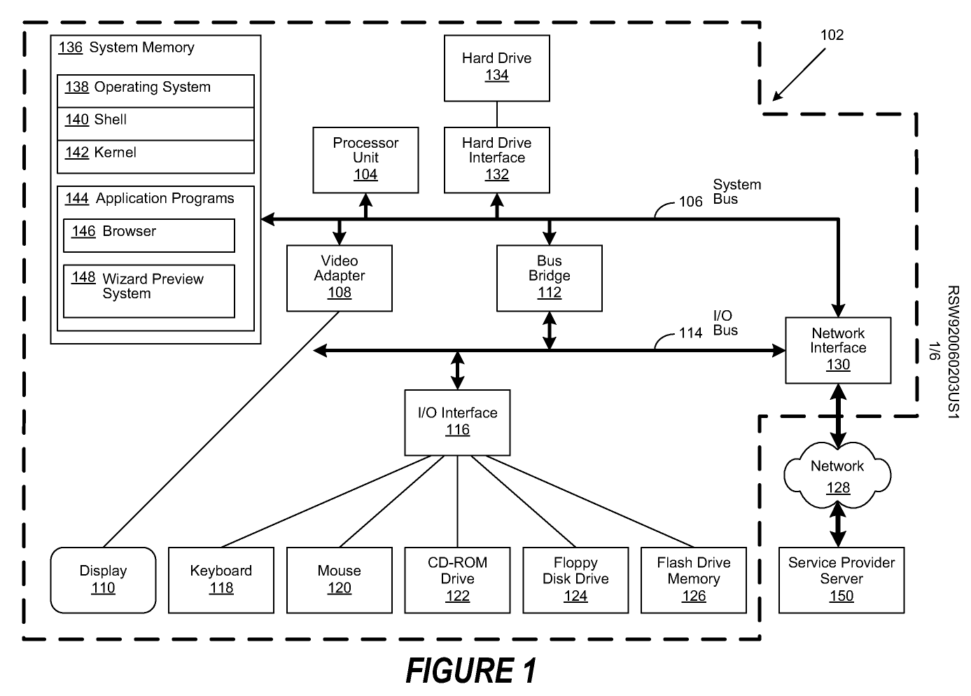

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 150 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 150.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140 for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and application programs 144, including memory management, process and task management, disk management, and mouse and keyboard management.

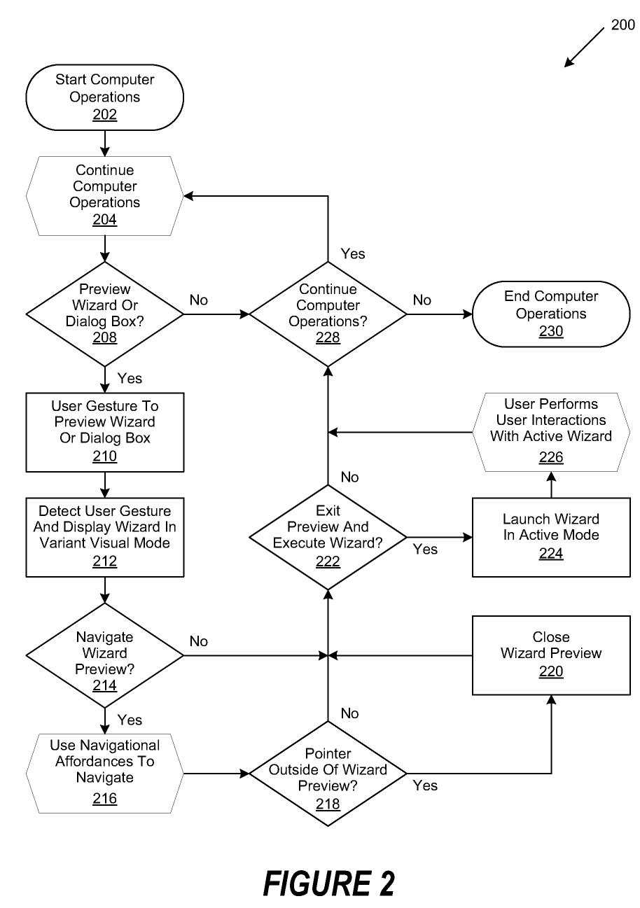

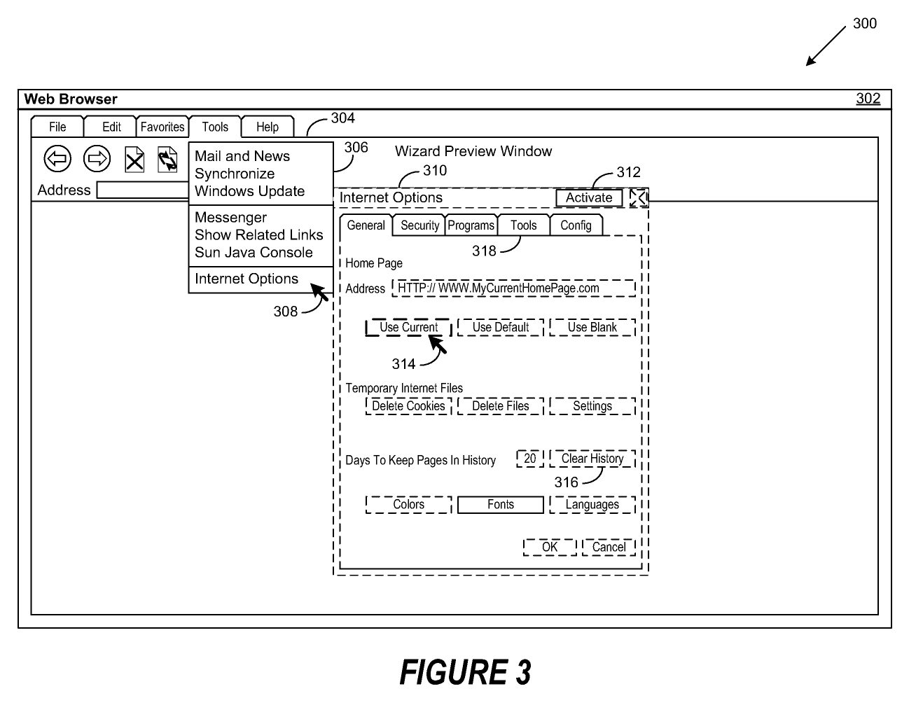

Application programs 144 may include a browser 146. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 150. Application programs 144 also include a wizard preview system 148. The wizard preview system 148 includes code for implementing the processes described in FIGS. 2-3 described herein below. In one embodiment, client computer 102 is able to download the wizard preview system 148 from a service provider server 150.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 shows a flow chart of the operation of an embodiment of a wizard preview system 200. In selected embodiments of the invention, computer operations are performed in a graphical user interface (GUI) beginning in step 202. Computer operations continue in step 204 until a computer wizard, dialog box or secondary dialog (hereinafter “wizard”) is selected to be previewed. If it is determined in step 208 to not preview the wizard, then it is determined in step 228 whether to continue computer operations. If it is determined in step 228 to continue computer operations, then they are continued beginning with step 204. Otherwise, computer operations are ended in step 230.

If it is determined in step 208 to preview the contents and user interaction steps of the wizard, then user gestures, such as a mouse hover or right click are performed on its associated menu item or graphical icon within the GUI in step 210. The user gestures are detected by the wizard preview system in step 212 and a non-executable replica of the wizard is displayed in a variant visual style. In one embodiment, the non-executable replica of the wizard is displayed in a translucent variant style within the GUI. The translucency of the wizard replica signifies to the user that the wizard is in preview mode and that it cannot be executed as an active wizard. In one embodiment, predetermined GUI widgets (e.g., buttons, text boxes, checkmarks, etc.) are disabled and do not respond to user gestures. A GUI widget is a virtual interface element with which a user interacts.

If it is decided in step 214 to navigate the user interaction steps of the non-executable replica of the wizard, then predetermined navigational widgets are used by the user in step 216. In one embodiment, predetermined GUI navigational widgets (e.g., tabs, previous/next buttons, and drop-down boxes) are enabled to allow the user to navigate from one wizard user interaction to another. If it is determined in step 218 that the graphical pointer has been moved outside the graphical boundaries of the non-executable replica of the wizard, then the non-executable replica of the wizard is closed in step 220. The user then decides in step 222 whether to convert the non-executable replica of the wizard to an executable wizard and initiate wizard operations. If the user decides to initiate operation of the executable wizard, then the wizard is launched in active mode in step 224 and the user performs predetermined user interactions with the executable wizard in step 226. However, if the user decides not to launch the wizard in active mode, it is then determined in step 228 whether to continue computer operations. If it is decided to continue computer operations, then they are continued beginning with step 204. Otherwise, computer operations are ended in step 230.

However, if the user decides in step 214 to not navigate the user interaction steps of the non-executable replica of the wizard, then the user decides in step 222 whether to convert the non-executable replica of the wizard to an executable wizard and initiate wizard operations. If the user decides to initiate operation of the executable wizard, then the wizard is launched in active mode in step 224 and the user performs predetermined user interactions with the executable wizard in step 226. However, if the user decides not to launch the wizard in active mode, it is then determined in step 228 whether to continue computer operations. If it is decided to continue computer operations, then they are continued beginning with step 204. Otherwise, computer operations are ended in step 230.

However, if it is determined in step 218 that the graphical pointer has not been moved outside the graphical boundaries of the non-executable replica of the wizard, then the user decides in step 222 whether to convert the non-executable replica of the wizard to an executable wizard and initiate wizard operations. If the user decides to initiate operation of the executable wizard, then the wizard is launched in active mode in step 224 and the user performs predetermined user interactions with the executable wizard in step 226. However, if the user decides not to launch the wizard in active mode, it is then determined in step 228 whether to continue computer operations. If it is decided to continue computer operations, then they are continued beginning with step 204. Otherwise, computer operations are ended in step 230.

FIG. 3 shows a graphical user interface of an embodiment of a wizard preview system 300 as implemented to view the contents and actions of a dialog box. In selected embodiments of the invention, a computer user interacts with the graphical user interface (GUI) of a computer application such as a web browser 302. During user interaction, the contents of menu tabs 304 are displayed in a drop-down menu 306 as a result of user gestures such as a mouse hover, left-click, or right click. Similar user gestures are performed by the user with the graphical pointer 308 to launch a non-executable replica of a dialog box 310. In one embodiment, the non-executable replica of the dialog box 310 is displayed in a translucent variant style within the GUI. The translucency of the wizard replica signifies to the user that the dialog box is in preview mode and that it cannot be executed as an active dialog box. In these and other embodiments, the non-executable replica of the dialog box 310 is contiguous to drop-down menu 306. If the graphical pointer 308 is moved outside the graphical boundaries of the non-executable replica of the dialog box 310, then the non-executable replica of the dialog box 310 is closed.

In one embodiment, predetermined GUI widgets (e.g., buttons, text boxes, checkmarks, etc.) 316 are provided for information purposes only, and as such, are disabled and do not respond to user gestures. In another embodiment, predetermined GUI navigational widgets (e.g., tabs, previous/next buttons, drop-down boxes) 318 are enabled to allow the user to navigate from one dialog box user interaction to another. For example, by placing the graphical pointer 314 on the appropriate button, the user can view its associated settings. In yet another embodiment, the user can convert the non-executable replica of the wizard to an executable wizard through user gestures performed with the activate button 312 as described in greater detail herein. In this embodiment, the executable wizard is launched in active mode and the user proceeds to perform predetermined user interactions.

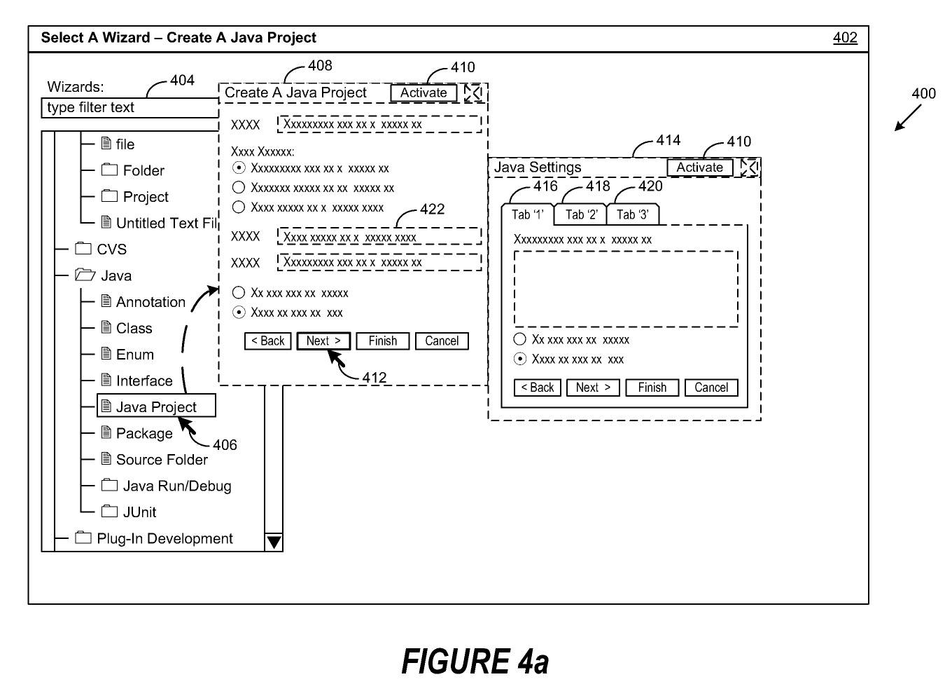

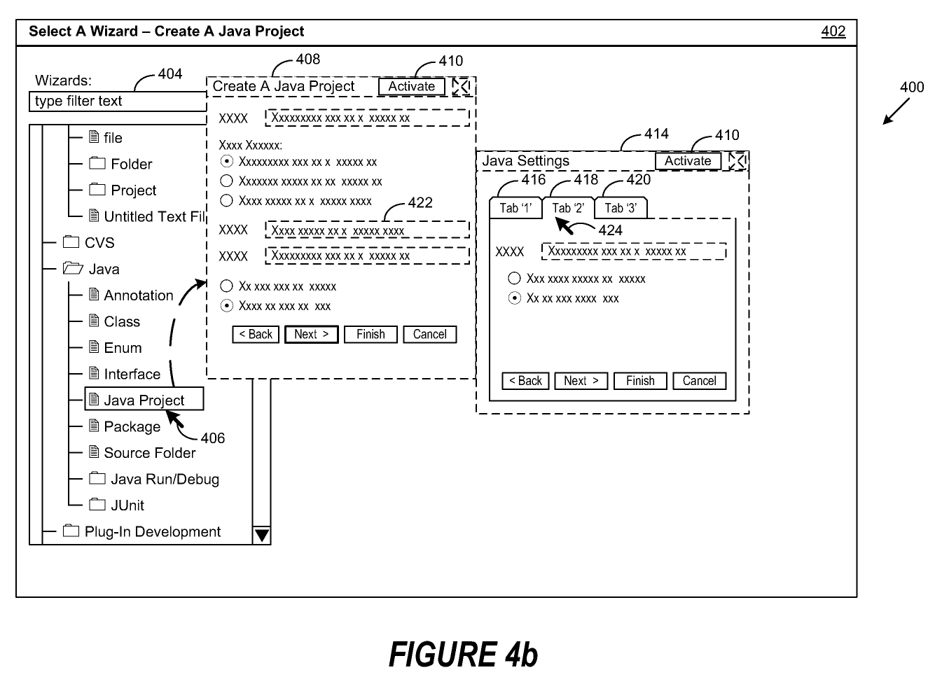

FIGS. 4a-b show a user interface of an embodiment of a wizard preview system 400 as implemented to iteratively view the user interaction steps of a computer wizard. In selected embodiments of the invention, a computer user interacts with the graphical user interface (GUI) of a computer application such as a Java project creator application 402. During user interaction, the user enters filter text into the wizard's text box 404 to display the associated directory tree of resources required to begin a project. As a result of user gestures such as a mouse hover, left-click, or right click performed by the user with the graphical pointer 406, a non-executable replica of a Java project creation wizard 408 is launched. In one embodiment, the non-executable replica of the Java project creation wizard 408 is displayed in a translucent variant style within the GUI. The translucency of the wizard replica signifies to the user that the wizard is in preview mode and that it cannot be executed as an active wizard. In these and other embodiments, the non-executable replica of the Java project creation wizard 408 is contiguous to the directory tree of resources. If the graphical pointer 412 is moved outside the graphical boundaries of the non-executable replica of the Java project creation wizard 408 or the Java Settings dialog box 414, then the non-executable replica of the wizard 408 is closed.

In one embodiment, predetermined GUI widgets (e.g., buttons, text boxes, checkmarks, etc.) 422 are provided for information purposes only, and as such, are disabled and do not respond to user gestures. In another embodiment, predetermined GUI navigational widgets (e.g., tabs, previous/next buttons, drop-down boxes) 412, 416, 418, 420 are enabled to allow the user to navigate from one dialog box user interaction to another. For example, as depicted in FIG. 4a, the user can view the associated settings of Tab ‘1’ 416 of the Java Settings dialog box 414 by placing the graphical pointer 412 on the “next” button of the non-executable replica of a Java project creation wizard 408. As similarly depicted in FIG. 4b, the user can view the associated settings of Tab ‘2’ 418 by placing the graphical pointer 424 on the Tab ‘2’ 418 of the Java Settings dialog box 414. Likewise, the user can view the associated settings of Tab ‘3’ 420 (not shown) by placing the graphical pointer 424 on the Tab ‘3’ 424 of the Java Settings dialog box 414. In yet another embodiment, the user can convert the non-executable replica of the wizard to an executable wizard through user gestures performed with the activate button 410 as described in greater detail herein. In this embodiment, the executable wizard is launched in active mode and the user proceeds to perform predetermined user interactions.

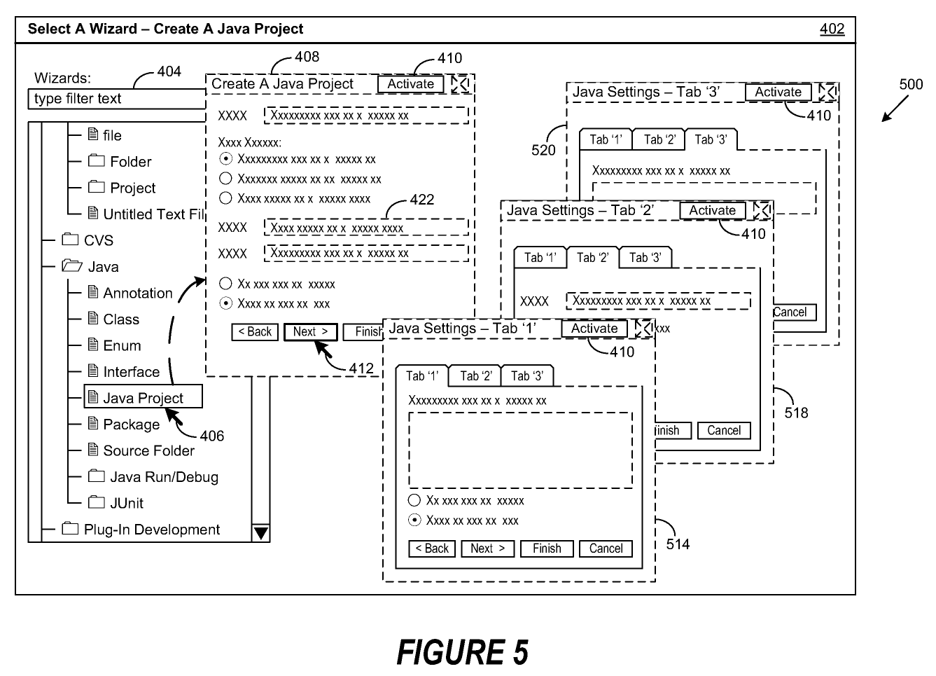

FIG. 5 shows a user interface of an embodiment of a wizard preview system 400 as implemented to concurrently view the user interaction steps of a computer wizard. In selected embodiments of the invention, a computer user interacts with the graphical user interface (GUI) of a computer application such as a Java project creator application 402. During user interaction, the user enters filter text into the wizard's text box 404 to display the associated directory tree of resources required to begin a project. As a result of user gestures such as a mouse hover, left-click, or right click performed by the user with the graphical pointer 406, a non-executable replica of a Java project creation wizard 408 is launched. In one embodiment, the non-executable replica of the Java project creation wizard 408 is displayed in a translucent variant style within the GUI. The translucency of the wizard replica signifies to the user that the wizard is in preview mode and that it cannot be executed as an active wizard. In these and other embodiments, the non-executable replica of the Java project creation wizard 408 is contiguous to the directory tree of resources. If the graphical pointer 412 is moved outside the graphical boundaries of the non-executable replica of the Java project creation wizard 408 or the Java Settings dialog boxes 514, 518, 520, then the non-executable replica of the wizard 408 is closed.

In one embodiment, predetermined GUI widgets (e.g., buttons, text boxes, checkmarks, etc.) 422 are provided for information purposes only, and as such, are disabled and do not respond to user gestures. In another embodiment, predetermined GUI navigational widgets (e.g., tabs, previous/next buttons, drop-down boxes) 412 are enabled to allow the user to navigate from one dialog box user interaction to another. For example, by placing the graphical pointer 412 on the “next” button of the non-executable replica of a Java project creation wizard 408, the user can concurrently view the associated settings of the Java Settings dialog boxes for Tab ‘1’ 514, Tab ‘2’ 518, and Tab ‘3’ 520. Similarly, the user can individually view (not shown) the associated settings of Java Settings dialog boxes Tab 1′ 514, Tab ‘2’ 518, and Tab ‘3’ 520 by placing the graphical pointer 412 each of the previewable dialog boxes. In yet another embodiment, the user can convert the non-executable replica of the wizard to an executable wizard through user gestures performed with the activate button 410 as described in greater detail herein. In this embodiment, the executable wizard is launched in active mode and the user proceeds to perform predetermined user interactions.

In a different embodiment, the non-executable replica of a Java project creation wizard 408 and the Java Settings dialog boxes for Tab ‘1’ 514, Tab ‘2’ 518, and Tab ‘3’ 520 are presented to the user in a static storyboard sequence to provide an overview of the user interaction steps of the wizard. In another embodiment, the non-executable replica of a Java project creation wizard 408 and the Java Settings dialog boxes for Tab ‘1’ 514, Tab ‘2’ 518, and Tab ‘3’ 520 are presented to the user in an animated sequence to provide an overview of the user interaction steps of the wizard. In this embodiment, animated links from each widget of a dialog box are implemented to show their association with other dialog boxes of the widget. It will be apparent to those of skill in the art that implementation of a non-executable replica of a wizard allows the user to preview the user interaction steps, required information, and resulting operation of the wizard without incurring the computational and operational overhead of launching the wizard itself.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for previewing the user interaction steps of a computer process presented in a first window of a graphical user interface, comprising:
generating a non-executable replica of a computer process comprising a plurality of predetermined user interaction steps; and,
presenting the non-executable replica of the computer process in a second window of the graphical user interface.

2. The method of claim 1, wherein the plurality of predetermined user interaction steps is displayed in a second window.

3. The method of claim 2, wherein the plurality of predetermined user interaction steps displayed in the second window comprises at least one dialog box.

4. The method of claim 2, wherein the plurality of predetermined user interaction steps displayed in the second window comprises at least one computer process wizard further comprising a plurality of dialog boxes.

5. The method of claim 1, wherein the non-executable replica of the computer process is displayed in a variant visual style of the computer process.

6. The method of claim 1, further comprising:
replicating the sequence of the plurality of predetermined user interaction steps of the computer process in the second window of the graphical user interface; and
navigating the replicated sequence of the plurality of predetermined user interaction steps using predetermined navigational widgets of the graphical user interface.

7. A system comprising:
a processor;
a data bus coupled to the processor; and
generating a non-executable replica of a computer process comprising a plurality of predetermined user interaction steps; and
a computer-usable medium embodying computer program code, the computer-usable medium being coupled to the data bus, the computer program code previewing the user interaction steps of a computer process presented in a first window of a graphical user interface and comprising instructions executable by the processor and configured for:
presenting the non-executable replica of the computer process in a second window of the graphical user interface;
replicating the sequence of the plurality of predetermined user interaction steps of the computer process in the second window of the graphical user interface; and
navigating the replicated sequence of the plurality of predetermined user interaction steps using predetermined navigational widgets of the graphical user interface.

8. The system of claim 7, wherein the plurality of predetermined user interaction steps is displayed in a second window.

9. The system of claim 8, wherein the plurality of predetermined user interaction steps displayed in the second window comprises at least one dialog box.

10. The system of claim 8, wherein the plurality of predetermined user interaction steps displayed in the second window comprises at least one computer process wizard further comprising a plurality of dialog boxes.

11. The system of claim 7, wherein the non-executable replica of the computer process is displayed in a variant visual style of the computer process.

12. The system of claim 7, wherein the instructions further comprise instructions executable by the processor and configured for:
replicating the sequence of the plurality of predetermined user interaction steps of the computer process in the second window of the graphical user interface; and
navigating the replicated sequence of the plurality of predetermined user interaction steps using predetermined navigational widgets of the graphical user interface.

13. A computer-usable medium embodying computer program code, the computer program code comprising computer executable instructions configured for:
generating a non-executable replica of a computer process comprising a plurality of predetermined user interaction steps;
presenting the non-executable replica of the computer process in a second window of the graphical user interface;
replicating the sequence of the plurality of predetermined user interaction steps of the computer process in the second window of the graphical user interface; and
navigating the replicated sequence of the plurality of predetermined user interaction steps using predetermined navigational widgets of the graphical user interface.

14. The computer-usable medium of claim 13, wherein the plurality of predetermined user interaction steps is displayed in a second window.

15. The computer-usable medium of claim 14, wherein The method of claim 2, wherein the plurality of predetermined user interaction steps displayed in the second window comprises at least one dialog box.

16. The computer-usable medium of claim 14, wherein the plurality of predetermined user interaction steps displayed in the second window comprises at least one computer process wizard further comprising a plurality of dialog boxes.

17. The computer usable medium of claim 13, wherein the non-executable replica of the computer process is displayed in a variant visual style of the computer process.

18. The computer-usable medium of claim 13, wherein the computer executable instructions further comprise computer executable instructions configured for:
replicating the sequence of the plurality of predetermined user interaction steps of the computer process in the second window of the graphical user interface; and
navigating the replicated sequence of the plurality of predetermined user interaction steps using predetermined navigational widgets of the graphical user interface.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
